(19) United States
(12) Patent Application Publication
(10) Pub. No.: US 2012/0092388 A1
(43) Pub. Date: Apr. 19, 2012

(54) DISPLAY CONTROL DEVICE, LIQUID CRYSTAL DISPLAY DEVICE, PROGRAM AND RECORDING MEDIUM ON WHICH THE PROGRAM IS RECORDED

(75) Inventor: Yuji Kamon, Osaka (JP)

(73) Assignee: SHARP KABUSHIKI KAISHA, Osaka-shi, Osaka (JP)

(21) Appl. No.: 13/266,722

(22) PCT Filed: Apr. 28, 2010
(86) PCT No.: PCT/JP2010/057617

§ 371 Date: Dec. 12, 2011

(30) Foreign Application Priority Data
Apr. 30, 2009 (JP) 2009-110479

(51) Int. Cl. G09G 3/36; G09G 5/02; G09G 5/10

(52) U.S. Cl. 345/690; 345/88; 345/89; 345/102

(57) ABSTRACT

To provide a display control device and a liquid crystal display device each of which prevents (i) an afterimage from appearing, (ii) an interpolation image broken due to a multiple rate drive from being visible, and (iii) a flicker from being visible due to black image insertion, a display control section (16) of the present invention for a liquid crystal television includes: a multiple rate conversion section (21) for driving a liquid crystal panel (26) at a multiple rate; a motion information detecting section (22) for detecting a motion of an image; a black insertion region determining section (23) for evaluating complexity of the motion of the image for each of a plurality of regions of the liquid crystal panel (26) to determine a black insertion region; and an LED luminance control section (24) for controlling an LED driving section (29) to (i) cause an LED (28) corresponding to a specific region, for which a motion of an original image has been determined during an interpolation image display period to be complex, to be off and (ii) cause the LED (28) corresponding to the specific region to have a luminance during an original image display period, the luminance being higher than a luminance of an LED (28) corresponding to a normal region.

### TECHNICAL FIELD

The present invention relates to a liquid crystal display device. In particular, the present invention relates to a liquid crystal display device including a direct type backlight that includes a plurality of LEDs as light sources.

### BACKGROUND ART

Conventional liquid crystal displays have a problem that an afterimage is visible when a moving image is displayed. This problem is caused, for example, as follows: A liquid crystal display hold-displays each frame (that is, continues displaying a current frame until it displays a next frame). Thus, due to human visual nature, an image of the next frame is displayed while an image of the current frame is remaining in the user's consciousness.

This problem can be solved by a known method of (i) a black insertion drive, in which within one frame period, a black image is displayed on the liquid crystal panel after an image is displayed thereon or (ii) a multiple rate drive, in which a display image is updated on the basis of a lower frequency.

The black insertion drive inserts a black or dark screen between frames to reduce a hold period of each frame, and thus makes it possible to carry out an image display closer to an image display based on an impulse drive. The black insertion drive, however, has a problem that since it inserts a black screen, it causes a flicker and a luminance decrease.

The multiple rate drive creates an interpolation image between frames, and inserts the interpolation image between frames to double the number of frames from an original video image. The multiple rate drive thus halves a hold period of each frame. The interpolation image created through interpolation is, however, an image that is created on the basis of a motion of an image between frames and that does not originally exist. The multiple rate drive thus has a problem that it tends to (i) create a broken interpolation image in the case where, in particular, an image having a plurality of overlapping motions is display, and consequently (ii) cause an unnatural image to be displayed.

The following describes an example case of displaying by a multiple rate drive a broadcast video image of marathon as illustrated in FIG. 17. This video image shows (i) a runner that is positioned substantially still on the screen and (ii) the background that moves to the left. For a region on the left side of the screen, the multiple rate drive can easily create an accurate interpolation image since the background moves in the same motion as its surroundings. Thus, no broken interpolation image is created for such a region. However, for a region that shows the runner and an upper right region that displays the time, there is an overlapping display of (i) an image that moves slowly and (ii) an image that moves fast. Thus, a broken interpolation image tends to be created.

To solve this problem, Patent Literature 1 discloses a liquid crystal display device that has an improved image quality for a moving image and an image containing both a moving portion and a still portion. Specifically, each frame based on an input video signal having a predetermined frame frequency (60 Hz) is divided into four subframes each having a subframe frequency that is four times as high as the above frame frequency. For a pixel region of a liquid crystal panel, an overdrive is carried out for a first subframe, and a normal drive is carried out for its subsequent subframes. Further, LED blocks of a backlight are controlled to be driven so as to blink twice with a predetermined time duration in-between during one frame period on the basis of a frequency (120 Hz) that is twice as high as the frame frequency. This arrangement prevents (i) a moving image from blurring on a display screen even in the case where liquid crystal does not have high responsivity, and (ii) a flicker from being visible on the screen due to the blinking of the backlight.

Patent Literature 2 discloses a liquid crystal display device that can divide a light-emitting region both to extend a dynamic range and to carry out a black insertion drive for a high contrast display.

### CITATION LIST

Patent Literature 1

Japanese Patent Application Publication, Tokukai, No. 2007-233102 A (Publication Date: Sep. 13, 2007)

Patent Literature 2

Japanese Patent Application Publication, Tokukai, No. 2009-175413 A (Publication Date: Aug. 6, 2009)

### SUMMARY OF INVENTION

### Technical Problem

The liquid crystal display device disclosed in Patent Literature 1, however, does not insert an interpolation image between frames, and thus cannot easily display a smooth moving image as compared to the case of displaying an interpolation image by a multiple rate drive.

The liquid crystal display device disclosed in Patent Literature 2, in the case of inserting a black display image, turns off all LEDs corresponding to scan lines for the black insertion image. Patent Literature 2 is, however, silent about a means to prevent a flicker or a luminance decrease both caused by the insertion of the black display image.

The present invention has been accomplished in view of the above problems. It is an object of the present invention to provide a display control device and a liquid crystal display device each of which prevents (i) an afterimage from appearing, (ii) an interpolation image broken due to a multiple rate drive from being visible, and (iii) a flicker from being visible due to black image insertion.

### Solution to Problem

In order to solve the above problems, a display control device of the present invention is a display control device for controlling an image display carried out by a liquid crystal panel that uses, as a light source, a backlight including a plurality of LEDs, the display control device including: multiple rate driving means for driving the liquid crystal panel at an n-fold rate by (i) dividing a frame period into n subframes (where n is an integer of 2 or greater) and (ii) inserting between frames an interpolation image created on a basis of a change in an original image; motion information detecting means for determining complexity of a motion of the original image for each of a plurality of regions of the liquid crystal panel; and LED luminance control means for controlling the plurality of LEDs so that an LED corresponding to a specific region, for which the motion of the original image has been determined by the motion information detecting means to be complex, has a first luminance during a period in which the interpolation image is displayed, the first luminance being lower than a luminance of an LED corresponding to a normal region, which is a region other than the specific region.

According to the above arrangement, the multiple rate driving means drives the liquid crystal panel at an n-fold rate and displays an original image and an interpolation image during one frame period. The motion information detecting means then determines complexity of a motion of the original image for each of a plurality of regions of the liquid crystal panel. The LED luminance control means controls the plurality of LEDs so that an LED corresponding to a specific region, for which the motion of the original image has been determined to be complex, has a first luminance during a period in which the interpolation image is displayed, the first luminance being lower than a luminance of an LED corresponding to a normal region. The interpolation image tends to be broken in the specific region, in which the motion of the image is complex. The above arrangement inserts a black image for only the specific region by lowering the luminance, during the period in which the interpolation image is displayed, of the LED corresponding to the specific region. This prevents (i) an afterimage from appearing, (ii) a broken interpolation image from being visible, and (iii) a flicker from being visible.

In contrast, the interpolation image is not likely to be broken in the normal region, in which the motion of the image is not complex. This prevents an afterimage from appearing due to a multiple rate drive. A flicker may be visible in the specific region. The above arrangement, however, allows a flicker to be visible only on a portion of the liquid crystal panel, since visibility of a flicker is limited to a region in which the motion of an image is complex. As such, it is possible to provide a display control device which prevents (i) an afterimage from appearing, (ii) an interpolation image broken due to a multiple rate drive from being visible, and (iii) a flicker from being visible due to black image insertion.

### Advantageous Effects of Invention

A display control device of the present invention is a display control device for controlling an image display carried out by a liquid crystal panel that uses, as a light source, a backlight including a plurality of LEDs, the display control device including: multiple rate driving means for driving the liquid crystal panel at an n-fold rate by (i) dividing a frame period into n subframes (where n is an integer of 2 or greater) and (ii) inserting between frames an interpolation image created on a basis of a change in an original image; motion information detecting means for determining complexity of a motion of the original image for each of a plurality of regions of the liquid crystal panel; and LED luminance control means for controlling the plurality of LEDs so that an LED corresponding to a specific region, for which the motion of the original image has been determined by the motion information detecting means to be complex, has a first luminance during a period in which the interpolation image is displayed, the first luminance being lower than a luminance of an LED corresponding to a normal region, which is a region other than the specific region. As such, it is possible to provide a display control device which prevents (i) an afterimage from appearing, (ii) an interpolation image broken due to a multiple rate drive from being visible, and (iii) a flicker from being visible due to black image insertion.

### BRIEF DESCRIPTION OF DRAWINGS

FIG. 1

FIG. 1 is a block view illustrating respective configurations of a display control section and a liquid crystal display of a liquid crystal television in accordance with Embodiment 1 of the present invention.

FIG. 2

FIG. 2 is a block view schematically illustrating an arrangement of the liquid crystal television in accordance with Embodiment 1 of the present invention.

FIG. 3

FIG. 3 is a flow chart illustrating content of a process carried out by a multiple rate conversion section of the display control section.

FIG. 4

FIG. 4 is a chart illustrating an example of how complexity of a motion is evaluated.

FIG. 5

FIG. 5 is a flow chart schematically illustrating content of a process carried out by a black insertion region determining section of the display control section.

FIG. 6

(a) of FIG. 6 is a plan view illustrating a layout of LEDs of a liquid crystal panel. (b) of FIG. 6 is a view illustrating a state in which a display screen of the liquid crystal panel has a plurality of regions. (c) of FIG. 6 is a view illustrating motions of images displayed on the liquid crystal panel.

FIG. 7

FIG. 7 is a view illustrating black insertion regions of the display screen of the liquid crystal panel.

FIG. 8

(a) of FIG. 8 is a view illustrating how the LEDs operate during a period in which an interpolation image is displayed. (b) of FIG. 8 is a view showing how the LEDs operate during a period in which an original image is displayed.

FIG. 9

FIG. 9 is a flow chart illustrating content of a process carried out by an LED luminance control section of the display control section.

FIG. 10

(a) of FIG. 10 is a view illustrating how bright the display screen of the liquid crystal panel is during the period in which the interpolation image is displayed. (b) of FIG. 10 is a view illustrating how bright the display screen of the liquid crystal panel is during the period in which the original image is displayed.

FIG. 11

(a) of FIG. 11 is a view illustrating how bright a backlight is during the period in which the interpolation image is displayed. (b) of FIG. 11 is a view illustrating how bright the backlight is during the period in which the original image is displayed. (c) of FIG. 11 is a view illustrating how bright the backlight is in average during one frame period.

FIG. 12

(a) of FIG. 12 is a view illustrating an example of multiple rate video data that have not been subjected to correction yet. (b) of FIG. 12 is a view illustrating an example of a display screen displayed on the liquid crystal panel in a case where no luminance control is carried out.

FIG. 13

FIG. 13 is a flow chart illustrating content of a process carried out by an image brightness control section of the display control section.

FIG. 14

FIG. 14 is a view illustrating the image brightness control by the image brightness control section.

FIG. 15

FIG. 15 is a view showing an example of multiple rate video data that have been subjected to the correction.

FIG. 16

FIG. 16 is a view showing an example of a display screen displayed on the liquid crystal panel in a case where the luminance control is carried out.

FIG. 17

FIG. 17 is a view illustrating an example of a moving image having regions in which differently moving images coexist.

FIG. 18

(a) of FIG. 18 is a cross-sectional view schematically illustrating a backlight in accordance with Embodiment 2 of the present invention. (b) of FIG. 18 is a plan view illustrating the backlight.

FIG. 19

FIG. 19 is a plan view illustrating another backlight in accordance with Embodiment 2 of the present invention.

FIG. 20

(a) FIG. 20 is a cross-sectional view schematically illustrating a still another backlight in accordance with Embodiment 2 of the present invention. (b) of FIG. 20 is a plan view illustrating the backlight.

FIG. 21

(a) of FIG. 21 is a cross-sectional view schematically illustrating yet another backlight in accordance with Embodiment 2 of the present invention. (b) of FIG. 21 is a plan view illustrating the backlight.

FIG. 22

FIG. 22 is a plan view illustrating a modified example of the backlight shown in FIG. 21.

FIG. 23

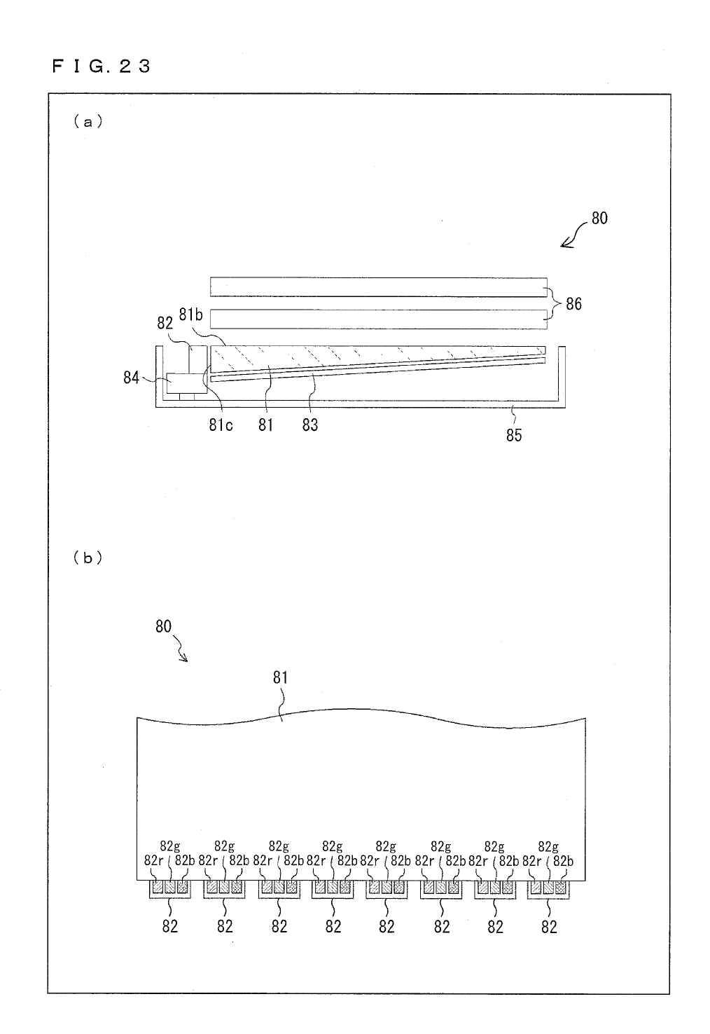

(a) FIG. 23 is a cross-sectional view schematically illustrating still another backlight in accordance with Embodiment 2 of the present invention. (b) of FIG. 23 is a plan view illustrating the backlight.

### DESCRIPTION OF EMBODIMENTS

### Embodiment 1

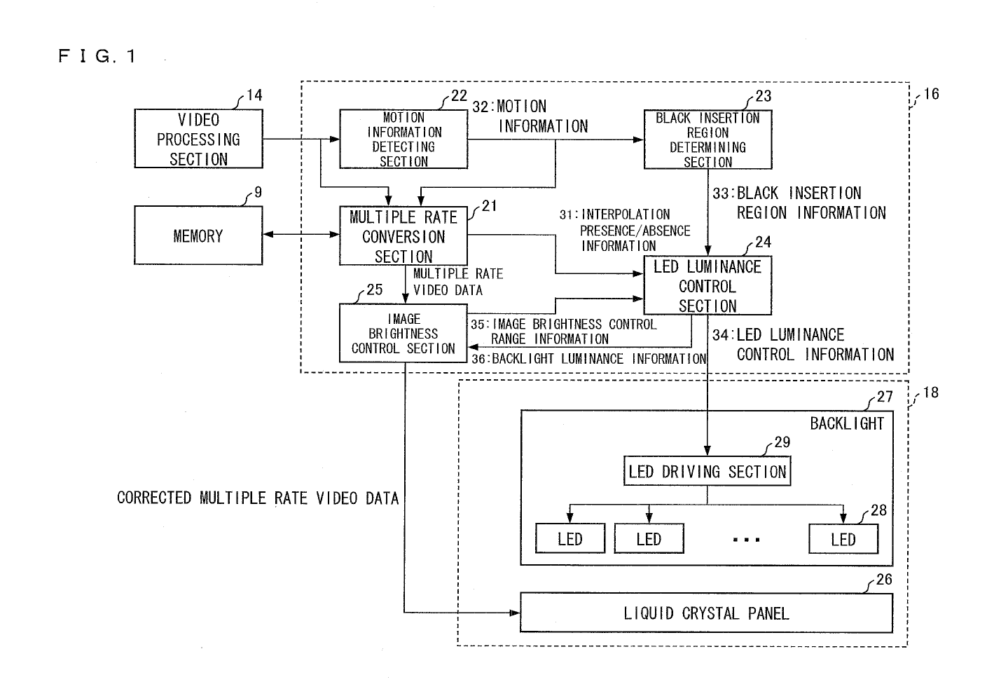

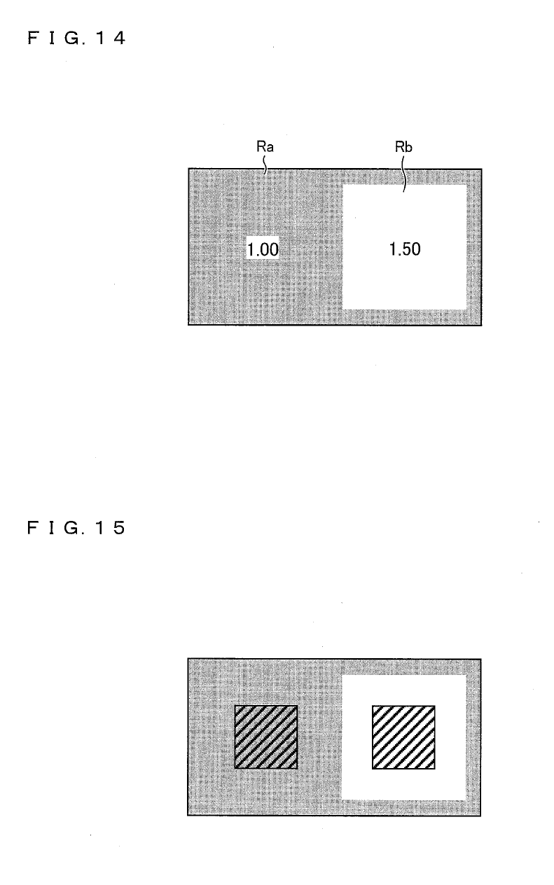

An embodiment of the present invention is described below with reference to FIGS. 1 through 16. Specifically, a liquid crystal television 1 of the present embodiment is capable of (i) receiving a broadcast wave and reproducing a broadcast program on the basis of the broadcast wave and (ii) receiving a video signal supplied from an external peripheral device and reproducing the video signal.

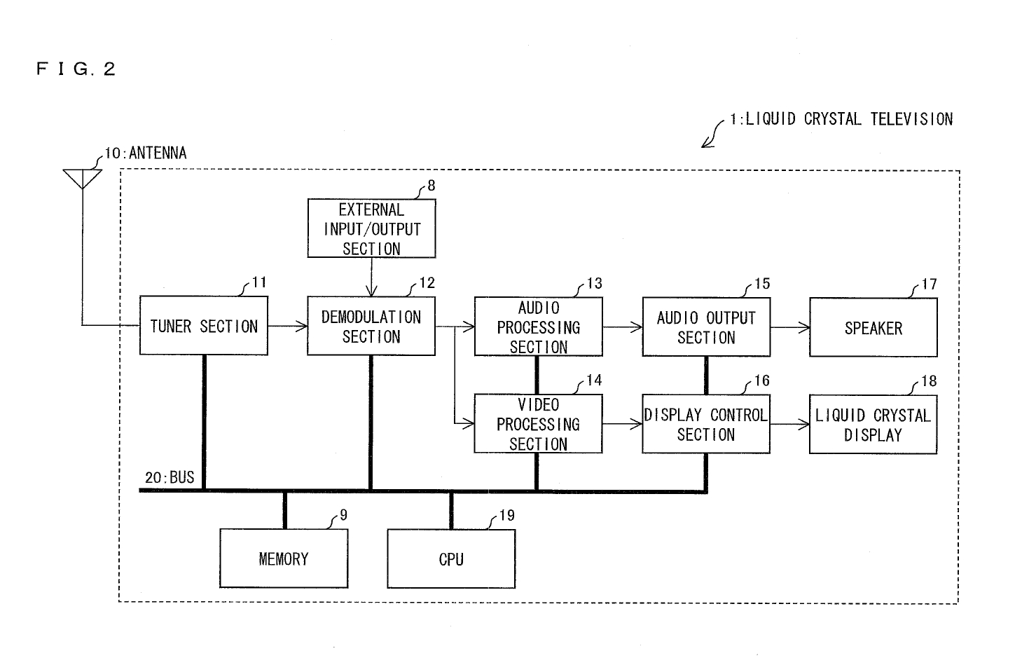

First, a schematic arrangement of the liquid crystal television 1 is described with reference to FIG. 2. FIG. 2 shows an embodiment of the present invention, and is a block diagram illustrating a schematic arrangement of the liquid crystal television 1.

As illustrated in FIG. 2, the liquid crystal television 1 mainly includes an external input/output section 8, a memory 9, an antenna 10, a tuner section 11, a demodulation section 12, an audio processing section 13, a video processing section 14, an audio output section 15, a display control section 16, a speaker 17, a liquid crystal display 18, and a CPU 19.

Out of the sections of the liquid crystal television 1, especially the tuner section 11, the demodulation section 12, the audio processing section 13, the video processing section 14, the audio output section 15, the display control section 16 transmit/receive various data and signals to/from the CPU 19 via a bus 20 or receive instructions for the respective sections from the CPU 19 via the bus 20. That is, the CPU 19 is capable of performing various controls over the tuner section 11, the demodulation section 12, the audio processing section 13, the video processing section 14, the audio output section 15, the display control section 16 via the bus 20.

In the liquid crystal television 1, the tuner section 11 receives a broadcast signal via the antenna 10, and the demodulation section 12 demodulates the broadcast signal. The broadcast signal demodulated by the demodulation section 12 is a multiplexed signal, and is separated into a video signal and an audio signal by a separating section (not shown). The audio signal is supplied to the audio processing section 13, and the video signal is supplied to the video processing section 14. Alternatively, in a case where a video signal is supplied from an external peripheral device (not shown) via the external input/output section 8, the demodulation section 12 causes the separating section (not shown) to separate the multiplexed video into a video signal and an audio signal. The audio signal is supplied to the audio processing section 13, and the video signal is supplied to the video processing section 14.

The audio processing section 13 decodes the audio signal and converts the audio signal into an audio output signal which is a format that can be outputted from the speaker 17 by the audio output section 15. Then, the audio processing section 13 transmits the audio output signal thus obtained to the audio output section 15. The audio output section 15 supplies the audio output signal thus received to the speaker 17 in synchronization with the video signal supplied to the liquid crystal display 18.

Meanwhile, the video processing section 14 decodes the video signal, and carries out image processes such as reducing noise of the video signal, adjusting contrast and sharpness of an image, and enlarging/reducing a display magnitude of the image so that the image can be properly displayed on the liquid crystal display 18. The video signal subjected to the image processes in the video processing section 14 is supplied to the display control section 16. The display control section 16 supplies the video signal to the liquid crystal display 18 in synchronization with the audio signal supplied from the audio output section 15.

The liquid crystal television 1 includes the memory 9 as a recording medium from/to which information can be read/written. In the memory 9, information and programs that are used in a case where the CPU 19 executes the various controls are stored. In addition, the video signal supplied from the video processing section 14 is temporarily stored in the memory 9.

In the present embodiment, the display control section 16 drives the liquid crystal panel of the liquid crystal display 18 at a multiple rate. Further, the display control section 16 drives/controls the backlight of the liquid crystal display 18 so that breakdown of an image caused by the multiple rate drive is not visible. The following describes a specific configuration of the display control section 16 with reference to FIG. 1.

FIG. 1 is a block diagram illustrating respective configurations of the display control section 16 and the liquid crystal display 18 shown in FIG. 2. The display control section 16 includes a multiple rate conversion section 21, a motion information detecting section 22, a black insertion region determining section 23, an LED luminance control section 24, and an image brightness control section 25. The liquid crystal display 18 includes a liquid crystal panel 26 and a backlight 27.

The backlight 27 is provided behind the liquid crystal panel 26, and includes a plurality of LEDs 28 and an LED driving section 29 for driving the LEDs 28. That is, the backlight 27 functions as a light source for the liquid crystal panel 26.

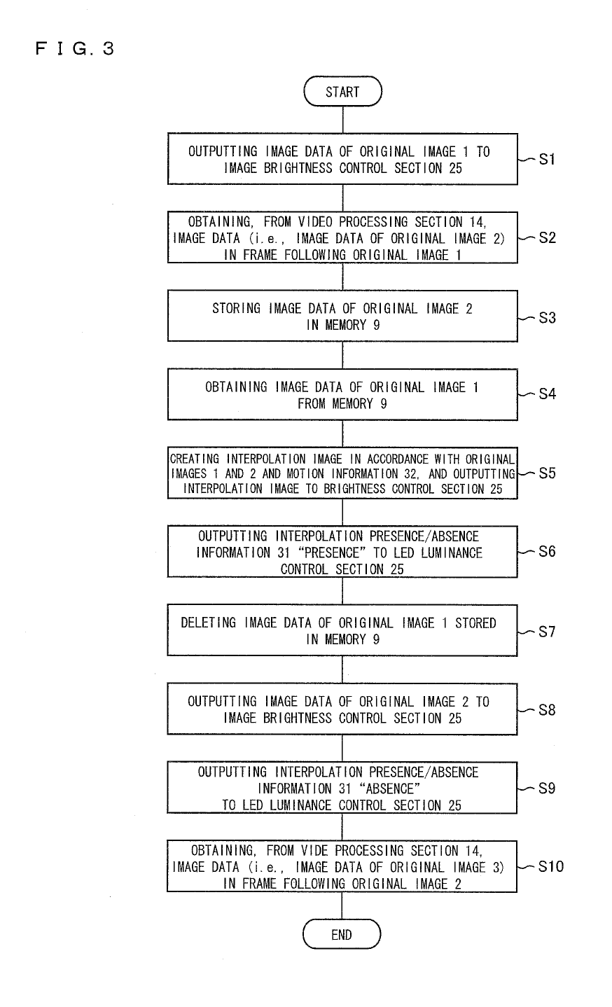

The video signal supplied from the video processing section 14 is supplied to the multiple rate conversion section 21 and the motion information detecting section 22. In the present embodiment, one frame period is divided into two subframes, and the multiple rate conversion section 21 outputs a multiple rate video signal for driving the liquid crystal panel 26 at a double rate. First, a process for the multiple rate drive by the multiple rate conversion section 21 is described with reference to FIG. 3.

FIG. 3 is a flowchart showing a process carried by the multiple rate conversion section 21. This flowchart shows a process carried out during a period in which (i) an original image 1, (ii) an interpolation image, and (iii) an original image 2 of a frame subsequent to the original image 1 are displayed.

First, in the first subframe of the two subframes, the multiple rate conversion section 21 supplies image data of the original image 1 to the image brightness control section 25 (Step S1), and obtains, from the video processing section 14, image data of the original image 2 of the frame subsequent to the original image 1 (S2). Subsequently, the multiple rate conversion section 21 causes the image data of the original image 2 thus obtained to be stored in the memory 9 (S3). At this moment, the image data of the original image 1 is stored in the memory 9 along with the image data of the original image 2. Then, the multiple rate conversion section 21 obtains the image data of the original image 1 from the memory 9 (S4). The multiple rate conversion section 21 creates an interpolation image on the basis of (i) the original image 1, (ii) the original image 2, and (iii) motion information 32 supplied from the motion information detecting section 22 that is described later. In the second subframe, the multiple rate conversion section 21 supplies, as a multiple rate video signal, data of the interpolation image to the image brightness control section 25 (S5). Simultaneously, the multiple rate conversion section 21 supplies, to the LED luminance control section 24, interpolation presence/absence information 31 indicative of “presence” of output of the data of the interpolation image (S6). The interpolation presence/absence information 31 and the LED luminance control section 24 are described later.

Subsequently, the multiple rate conversion section 21 deletes the image data of the original image 1 stored in the memory 9 (S7). In the first subframe of a next frame, the multiple rate conversion section 21 supplies, as a multiple rate video signal, the image data of the original image 2 to the image brightness control section 25 (S8). Simultaneously, the multiple rate conversion section 21 supplies, to the LED luminance control section 24, interpolation presence/absence information 31 indicative of “absence” of output of the data of the interpolation image (S9). Then, the multiple rate conversion section 21 obtains, from the video processing section 14, image data of an original image 3 of a frame subsequent to the original image 2 (S10). After that, processes similar to those in S3 to S9 are repeated.

As a result of the above process, the interpolation image is inserted between the original image 1 and the original image 2, so that the liquid crystal panel 26 is driven at a two-fold rate. However, the multiple rate conversion section 21 cannot create an appropriate interpolation image as for a video in which images of different motions are present as illustrated in FIG. 17. In view of this, in the present embodiment, a portion of an interpolation image in which portion breakdown occurs is displayed in black or made dark so that such a breakdown portion is not visible. This display control is accomplished by the motion information detecting section 22, the black insertion region determining section 23, the LED luminance control section 24, and the image brightness control section 25 shown in FIG. 1.

As described above, the video signal supplied from the video processing section 14 is supplied also to the motion information detecting section 22. The motion information detecting section 22 compares original images of respective frames so as to detect a motion of the original images displayed on the liquid crystal panel 26. The motion information 32 indicative of a result of the detection of the motion of the original images is supplied to the multiple rate conversion section 21 and the black insertion region determining section 23. The black insertion region determining section 23 evaluates, on the basis of the motion information 32, complexity of a motion of the original images for each of a plurality of regions of the liquid crystal panel 26. The black insertion region determining section 23 determines, as a black insertion region which is displayed in black or made dark, regions for which a motion is highly complex, such as (i) a region in which motions in a plurality of directions are observed and (ii) a region in which a still part and a motion part overlap each other.

The “complexity of a motion” used herein refers to unevenness of directions and magnitudes of motions. In the present embodiment, the complexity of a motion is used as an indicator for detecting a region of an interpolation image in which region breakdown is likely to occur. In other words, a region in which a motion is complex is (i) a region in which breakdown of an interpolation image is likely to occur or (ii) a region in which directions of motions in an image are not even. The evaluation as to whether a motion is complex or not may be carried out by calculating an average of vector values of motions in a plurality of parts (four parts in the present embodiment) of an image within a region and then determining whether variance of the vector values of the respective parts is larger than a predetermined value or not.

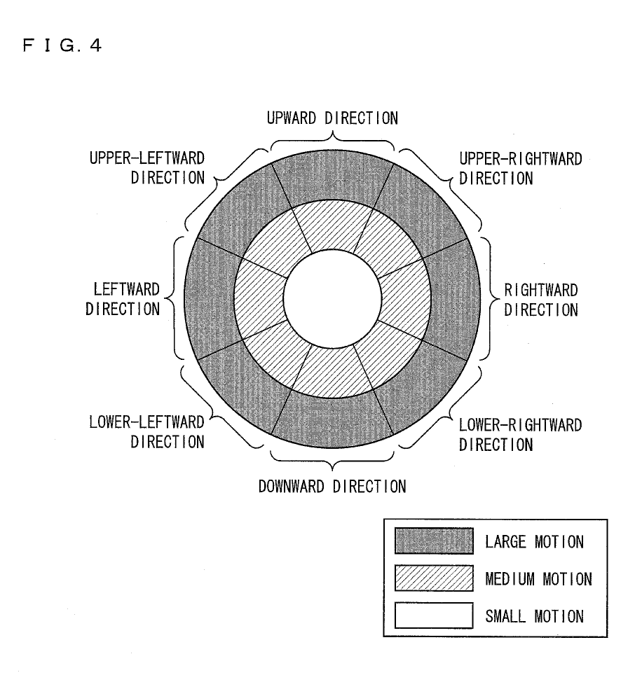

A specific example of a method for evaluating complexity of a motion without using variance in vector values is described with reference to FIG. 4. FIG. 4 is a classification table in which all motions in each region of an original image are classified. First, points indicative of the respective motions are plotted at corresponding positions of the classification table on the basis of a direction and a magnitude of each motion in the region. In the classification table, a section that is farther away from a central portion of the table indicates that a motion is larger, and a direction in which a section is located with respect to the central portion corresponds to a direction of a motion. Next, a motion difference is calculated as for each combination of the motions in the region. A motion difference is the minimum number of boundary lines which exists between one point and another. Note that an intersection of a side of a section with a side of another section is not crossed. Out of the motions differences, the largest motion difference is determined as complexity of a motion in the region.

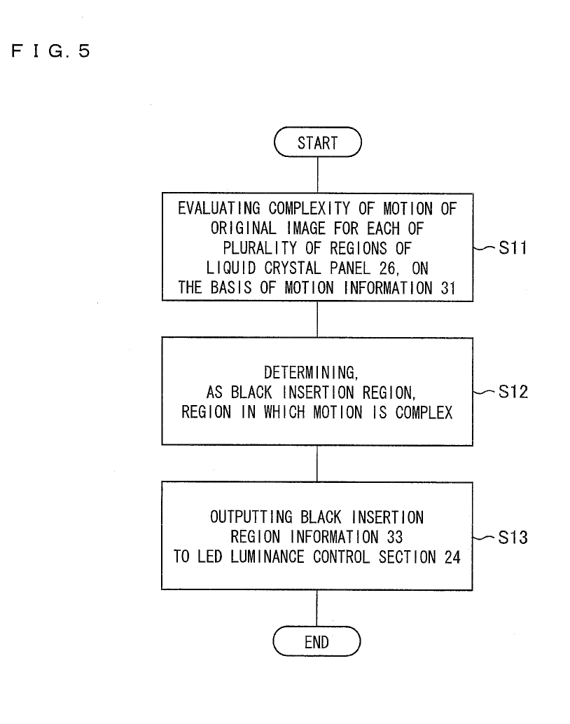

FIG. 5 is a flowchart showing an outline of a process carried out by the black insertion region determining section 23. In response to receipt of the motion information 32 from the motion information detecting section 22, the black insertion region determining section 23 evaluates, on the basis of the motion information 32, complexity of a motion of original images for each of a plurality of regions of a display screen of the liquid crystal panel 26 (S11). Thus, the black insertion region determining section 23 determines, as a black insertion region, a region in which a motion is complex (S 12), and supplies, to the LED luminance control section 24, black insertion region information 33 indicative of the black insertion region (S13).

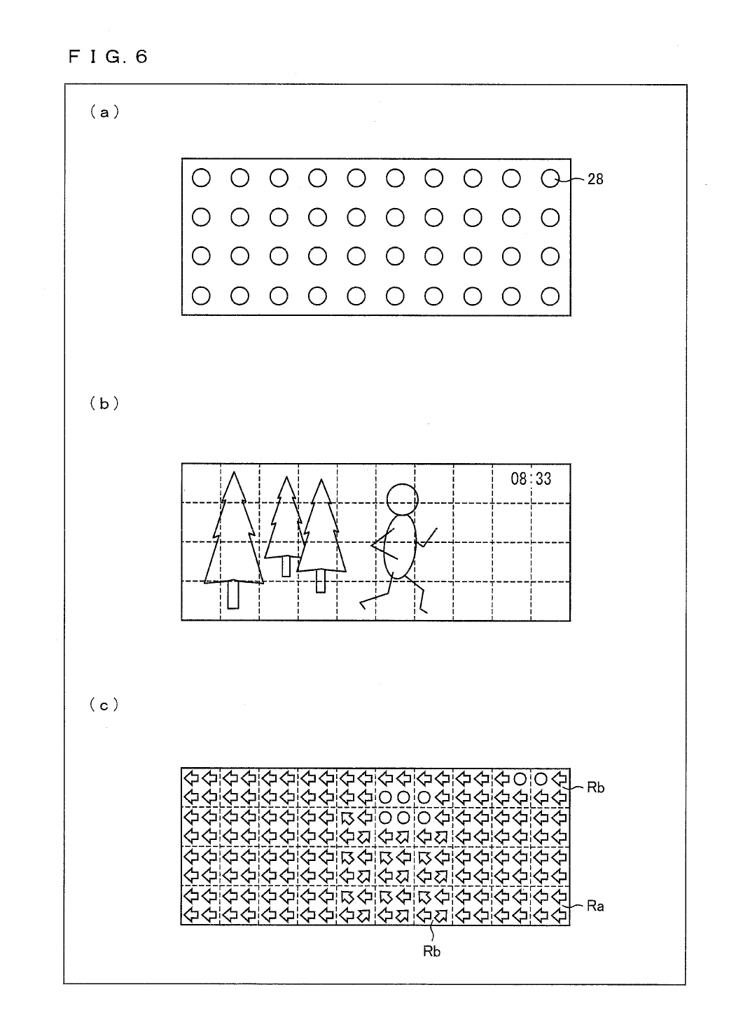

A more specific process carried out by the black insertion region determining section 23 is described below with reference to FIG. 6.

(a) of FIG. 6 is a plan view illustrating how the LEDs 28 are provided in the liquid crystal panel 26. (b) of FIG. 6 illustrates a state in which a display screen of the liquid crystal panel 26 has been divided into a plurality of regions R. (c) of FIG. 6 illustrates a motion of an image to be displayed in the liquid crystal panel 26.

Forty (ten-by-four) LEDs 28 are provided in the liquid crystal panel 26 (see (a) of FIG. 6). Note that the present embodiment uses white LEDs as the LEDs 28. The black insertion region determining section 23 divides the display screen of the liquid crystal panel 26 into 40 regions R (see (b) of FIG. 6), so as to evaluate a motion of an image to be displayed in the liquid crystal panel 26 for each of the regions R in accordance with the motion information 32 (see (c) of FIG. 6).

Arrows (see (c) of FIG. 6) indicate directions in which an image moves, and circles (see (c) of FIG. 6) indicate still parts. In a case where the image moves in a region complexly in non-uniform directions, the black insertion region determining section 23 determines that the region is a black insertion region Rb. In contrast, in a case where the image moves in a region uniformly, the black insertion region determining section 23 determines that the region is a normal region Ra.

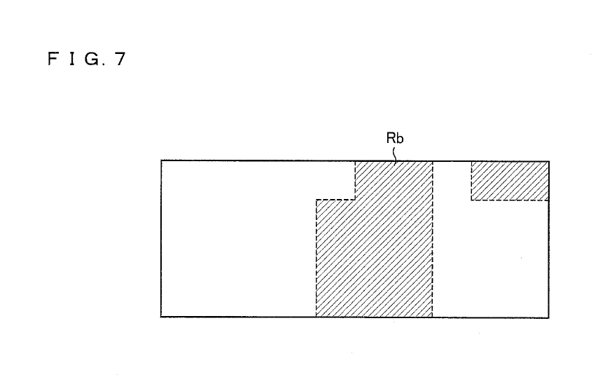

The black insertion region Rb of the display screen of the liquid crystal panel 26 is thus determined (see FIG. 7). The black insertion region determining section 23 supplies, to the LED luminance control section 24, the black insertion region information 33 indicative of the black insertion region Rb. Note that the black insertion region Rb corresponds to a “specific region” recited in the Claims.

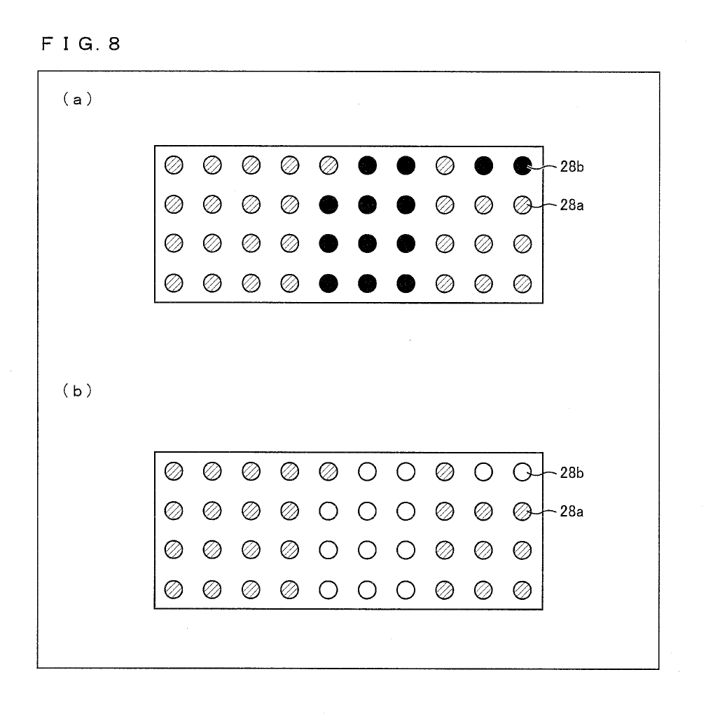

The LED luminance control section 24 supplies LED luminance control information 34 to the LED driving section 29 in accordance with the black insertion region information 33, so as to instruct the LED driving section 29 to carry out luminance control differently with respect to an LED 28 (hereinafter referred to as an LED 28a) corresponding to the normal region Ra and an LED 28 (hereinafter referred to as an LED 28b) corresponding to the black insertion region Rb. According to the present embodiment, the LED luminance control section 24 controls the LED driving section 29 so that (i) the LED 28b is turned off during a period in which an interpolation image is displayed, and (ii) the LED 28b has a higher luminance than the LED 28a during a period in which an original image is displayed. FIG. 8 illustrates a state of the LEDs 28.

(a) of FIG. 8 illustrates a state of the LEDs 28 during the period in which the interpolation image is displayed. (b) of FIG. 8 illustrates a state of the LEDs 28 during the period in which the original image is displayed. The LED 28a has an identical luminance both during the period in which the interpolation image is displayed and during the period in which the original image is displayed. In contrast, the LED 28b is controlled to be turned off during the period in which the interpolation image is displayed (see (a) of FIG. 8) and to have a higher luminance than the LED 28a during the period in which the original image is displayed.

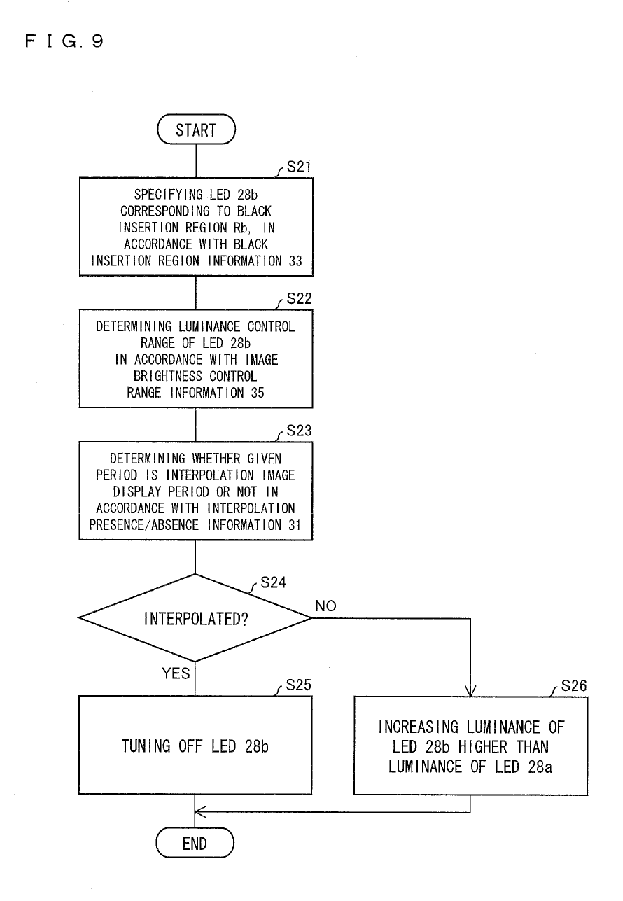

FIG. 9 is a flowchart illustrating a process carried out by the LED luminance control section 24. The LED luminance control section 24 which has received the black insertion region information 33 from the black insertion region determining section 23 specifies the LED 28b corresponding to the black insertion region Rb in accordance with the black insertion region information 33 (S21). Subsequently, in accordance with image brightness control range information 35 received from the image brightness control section 25, the LED luminance control section 24 determines a luminance control range of the LED 28b, i.e., (i) a luminance of the LED 28b which luminance is obtained during the period in which the interpolation image is displayed and (ii) a luminance of the LED 28b which luminance is obtained during the period in which the original image is displayed (S22). The image brightness control section 25 and the image brightness control range information 35 are specifically described later.

Simultaneously, in accordance with interpolation presence/absence information 31 received from the multiple rate conversion section 21, the LED luminance control section 24 determines whether or not the current period is the period in which the interpolation image is displayed (S23). In a case where the LED luminance control section 24 determines that the current period is the period in which the interpolation image is displayed (“YES” at S24), the LED luminance control section 24 instructs the LED driving section 29 to turn off the LED 28b (S25). In contrast, in a case where the LED luminance control section 24 determines that the current period is the period in which the original image is displayed (“NO” at S24), the LED luminance control section 24 instructs the LED driving section 29 to cause the LED 28b to have a higher luminance than the LED 28a (S26).

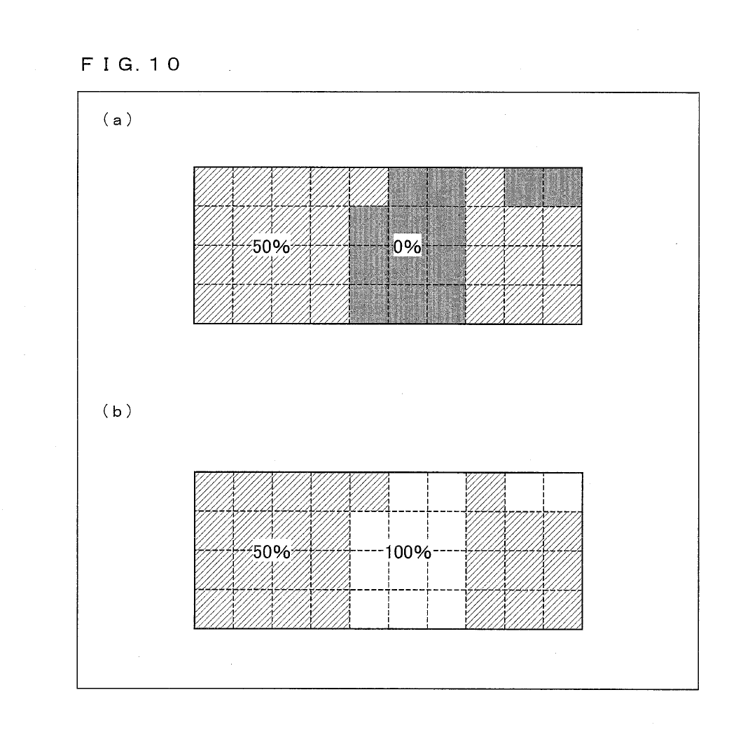

Next, FIG. 10 illustrates a brightness of the display screen of the liquid crystal panel 26 which brightness is obtained in a case where the control described above is carried out. (a) of FIG. 10 illustrates a brightness of the display screen of the liquid crystal panel 26 which brightness is obtained during the period in which the interpolation image is displayed. (b) of FIG. 10 illustrates a brightness of the display screen of the liquid crystal panel 26 which brightness is obtained during the period in which the original image is displayed. During the period in which the interpolation image is displayed, the black insertion region Rb has a brightness of 0% of a maximum brightness (see (a) of FIG. 10). During the period in which the original image is displayed, the black insertion region Rb has a brightness of 100% of the maximum brightness (see (b) of FIG. 10). In contrast, both during the period in which the interpolation image is displayed and during the period in which the original image is displayed, the normal region Ra has a brightness of 50% of the maximum brightness.

Since an image does not move complexly in the normal region Ra, an interpolation image is less likely to be broken. Accordingly, a natural image with no afterimage is displayed in the normal region Ra by a normal multiple rate drive. In contrast, an interpolation image is highly likely to be broken in the black insertion region Rb due to a multiple rate drive. Therefore, according to the present embodiment, during the period in which the interpolation image is displayed, the LED 28b is turned off and the black insertion region Rb has a brightness of 0% of the maximum brightness (see (a) of FIG. 10). According to this, even if the interpolation image is broken in the black insertion region Rb during the period in which the interpolation image is displayed, a broken part is not visible.

During the period in which the original image is displayed, the black insertion region Rb has a higher brightness than the normal region Ra, so that a reduction in brightness due to black insertion in the black insertion region Rb can be compensated for. Further, according to the present embodiment, an average brightness of the black insertion region (an average luminance of the LED 28b) which average brightness is obtained during a frame period is controlled to be equal to a brightness of the normal region Ra (an average luminance of the LED 28a). This allows the entire display screen of the liquid crystal panel 26 to have a perfectly uniform brightness.

A flicker may occur in the black insertion region Rb. However, since the black insertion region Rb is limited to a region in which an image moves complexly, a region in which a flicker occurs can be limited to a part of the display screen. Therefore, according to the present embodiment, it is possible to prevent (i) an afterimage from appearing due to a multiple rate drive, (ii) an image broken due to a multiple rate drive from being visible, and (iii) a flicker from occurring due to black insertion.

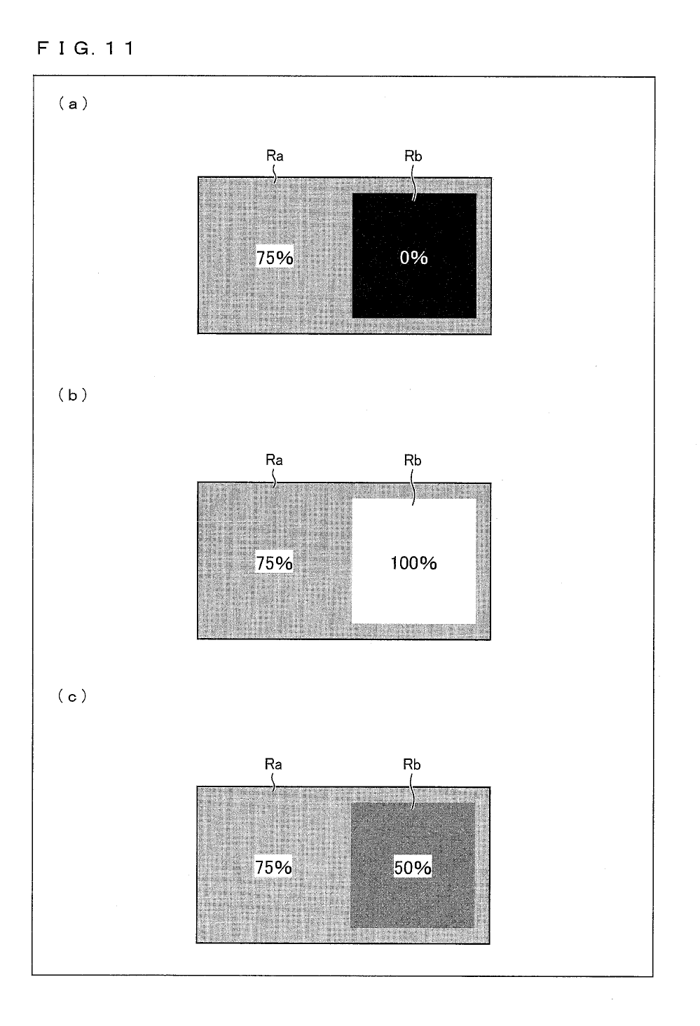

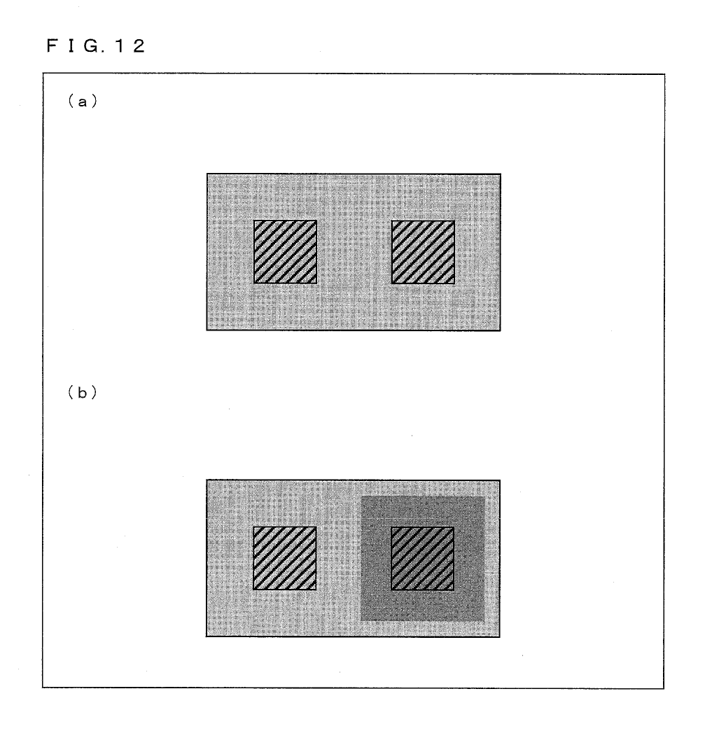

Assume here that the normal region Ra has a brightness which is higher than 50% of the maximum brightness. For example, as illustrated in FIG. 11, in a case where (i) the normal region Ra has a brightness of 75% of the maximum brightness and (ii) the black insertion region Rb has a brightness of 0% of the maximum brightness during the period in which the interpolation image is displayed (see (a) of FIG. 11), the black insertion region Rb has a lower brightness than the normal region Ra since the black insertion region Rb has an average brightness of 50% even if the black insertion region Rb has a brightness of 100% of the maximum brightness during the period in which the original image is displayed (see (b) of FIG. 11). As a result, in a case where multiple rate video data (see (a) of FIG. 12) is supplied to the liquid crystal panel 26 without being subjected to brightness control, a part of an image displayed on the liquid crystal panel 26 darkens (see (b) of FIG. 12). As described earlier, according to the present embodiment, in a case where a low/high luminance of the LED 28b in the black insertion region Rb cannot be offset, the image brightness control section 25 (see FIG. 1) compensates for a reduction in brightness of the black insertion region Rb, so that the entire screen can have a uniform brightness.

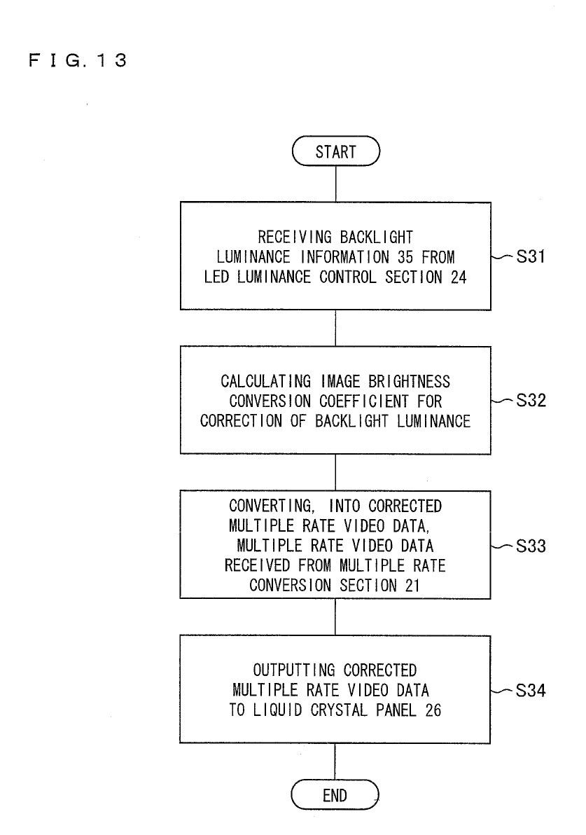

FIG. 13 is a flowchart illustrating a process carried out by the image brightness control section 25. The image brightness control section 25 which has received backlight luminance information 36 (see (c) of FIG. 11) supplied from the LED luminance control section 24 (see FIG. 1) (S31) calculates an image brightness conversion coefficient which compensates for a backlight luminance of the black insertion region Rb (S32). The image brightness conversion coefficient refers to a conversion rate for an image brightness of multiple rate video data which is supplied from the multiple rate conversion section 21 to the image brightness control section 25. A screen luminance of the liquid crystal panel 26 is obtained by multiplying an image brightness and a backlight luminance. Here, the black insertion region Rb has a backlight luminance which is two thirds of a backlight luminance of the normal region Ra (50%/75%=2/3). Therefore, the image brightness conversion coefficient for the black insertion region Rb of the multiple rate video data is calculated as 1.50. Note that the image brightness conversion coefficient for the normal region Ra is 1.00 since an image luminance is not changed in the normal region Ra.

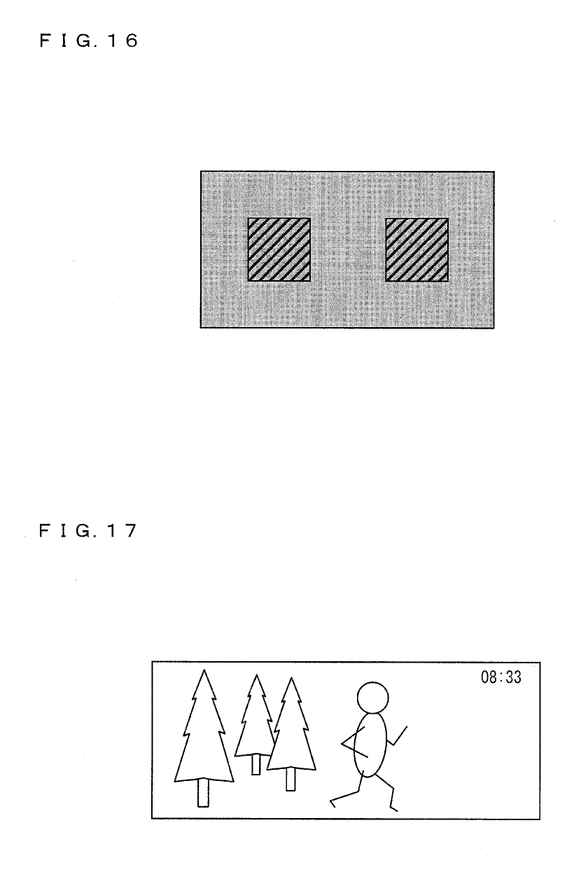

Subsequently, in accordance with the image brightness conversion coefficient thus calculated, the image brightness control section 25 converts the multiple rate video data received from the multiple rate conversion section 21 to corrected multiple rate video data (see FIG. 15) (S33), so as to supply the corrected multiple rate video data to the liquid crystal panel 26 (S34). As a result, a screen which has an entirely uniform brightness is displayed on the liquid crystal panel (see FIG. 16).

As described earlier, in a case where the black insertion region Rb has a lower backlight luminance than the normal region Ra, it is possible to compensate for a reduction in backlight luminance due to black insertion by increasing an image brightness of the black insertion region Rb of the multiple rate video data.

Note that the image brightness control section 25 cannot necessarily carry out image brightness control freely since an image brightness has an upper limit. For example, in a case where (i) the image brightness can be controlled within a range of 0 to 255 and (ii) the multiple rate video data which is supplied from the multiple rate conversion section 21 and has not been corrected has a brightness of 255, it is impossible to correct the multiple rate video data so that the multiple rate video data has an image brightness higher than 255.

Therefore, according to the present embodiment, the image brightness control section 25 supplies a range of a correctable image brightness as the image brightness control range information 35 (described earlier) to the LED luminance control section 24. According to this, a backlight luminance control range of the LED luminance control section 24 is specified so that the image brightness control section 25 can compensate for a rate of change in luminance of the LED 28b of the black insertion region Rb with respect to a luminance of the normal region Ra, i.e., so that the image brightness control section 25 can carry out brightness control within a range in which a pixel value is not saturated.

In this case, the LED luminance control section 24 sets a luminance of the LED 28b of the black insertion region Rb to be higher (40% of the maximum luminance, for example) during the period in which the interpolation image is displayed than during a period in which the LED 28b is turned off. According to this, breakdown in the interpolation image is slightly easily visible. Though an effect of hiding the breakdown in the interpolation image due to black insertion is reduced, it is possible to prevent a reduction in brightness due to saturation of a pixel value, so as to allow the display screen to have a more uniform brightness. A brightness of the black insertion region Rb is thus appropriately set within a range in which a pixel of the liquid crystal panel 26 is not saturated and in view of visibility of breakdown in the interpolation image and uniformity of a brightness of the entire display screen.

A standard by which the black insertion region determining section 23 determines whether or not an image moves complexly is appropriately set in view of, for example, visibility of breakdown due to a multiple rate drive and a ratio of a region in which a flicker occurs due to black insertion. For example, in a case where a standard of complexity is set low by which standard the black insertion region determining section 23 determines that a region is the black insertion region Rb, breakdown is less likely to occur in the normal region Ra. This makes it possible to more securely prevent breakdown due to a multiple rate drive from being visible. However, in this case, since a ratio of the black insertion region Rb to the liquid crystal panel 26 increases, a flicker is more likely to be conspicuous. In contrast, in a case where the standard of complexity is set high by which standard the black insertion region determining section 23 determines that a region is the black insertion region Rb, a ratio of the black insertion region Rb to the liquid crystal panel 26 decreases. This allows a flicker to occur more limitedly. However, breakdown is more likely to occur in the normal region Ra.

According to the present embodiment, each of the regions R into which the liquid crystal panel 26 is divided corresponds to an LED 28. Alternatively, each of the regions R may correspond to a plurality of LEDs 28. In this case, each minute region is more difficult to control as compared to the case where each of the regions R corresponds to an LED 28. However, since this case requires fewer units of control of LEDs 28, the LED luminance control section 24 can be arranged more easily.

According to the present embodiment, the multiple rate conversion section 21 drives the liquid crystal panel 26 at a double rate. Alternatively, the multiple rate conversion section 21 may drive the liquid crystal panel 26 at a triple or higher rate.

Note that each block of the liquid crystal television 1, especially the multiple rate conversion section 21, the motion information detecting section 22, the black insertion region determining section 23, the LED luminance control section 24, and the image brightness control section 25 each of which is included in the display control section 16 may be constituted by a hardware logic or implemented by software by use of the CPU 19 as described below.

Namely, the liquid crystal television 1 includes (i) the CPU (central processing unit) 19 which executes a command of a control program that implements each function of the liquid crystal television 1, (ii) a ROM (read only memory) in which the control program is stored, (iii) a RAM (random access memory) which extracts the control program, (iv) a storage device (a recording medium) such as the memory 9 in which the control program and various sets of data are stored, and (v) the like. The object of the present invention is attainable by supplying, to the liquid crystal television 1, a recording medium in which program codes (an executable program, an intermediate code program, and a source program) of a control program of the liquid crystal television 1, the control program being software that implements the each function are computer-readably recorded and causing a computer (the CPU 19) of the liquid crystal television 1 to read out and carry out the program codes recorded in the recording medium.

The liquid crystal television 1 may be arranged to be connectable with a communication network, via which the program codes are supplied thereto.

Note that the present invention can also be realized in a form of a computer data signal in which the program codes are embodied by an electronic transmission and which is embedded in carrier waves.

### Embodiment 2

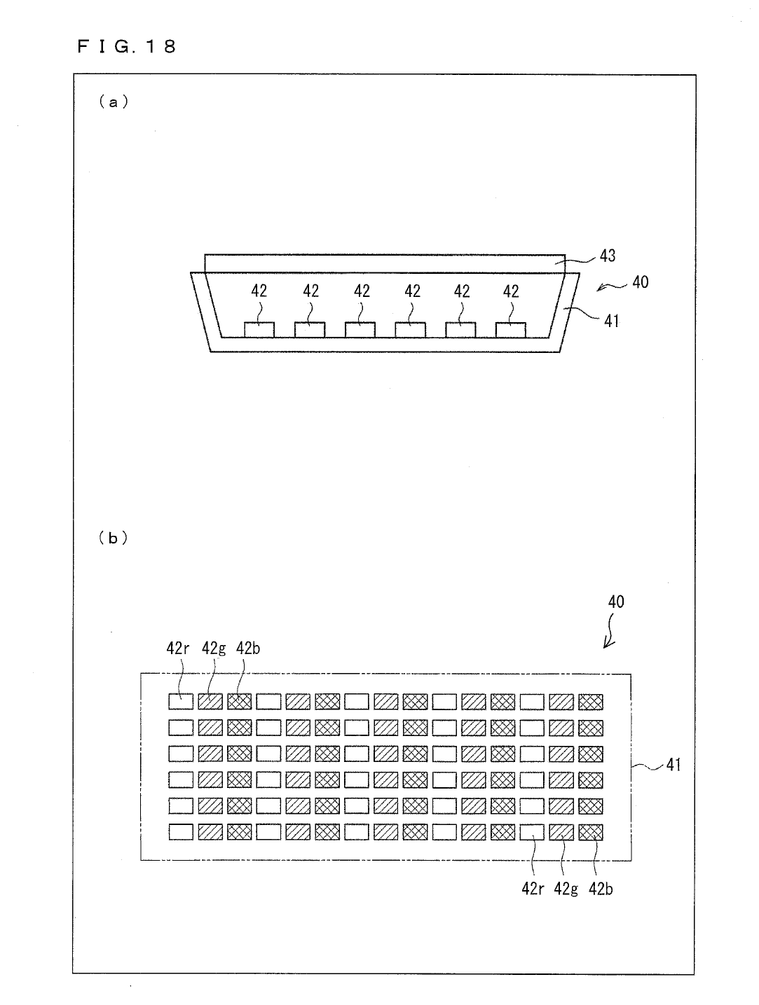

Another embodiment of the present invention is described below with reference to FIGS. 18 through 23. Embodiment 1 above describes an example that includes, as a backlight, a direct type backlight including a plurality of white LEDs. The present invention is, however, not limited to such an arrangement, provided that the backlight is capable of controlling respective luminances of a plurality of regions of the liquid crystal panel. The present embodiment describes another specific example of a backlight and LEDs both usable in the present invention.

The description below first deals with a direct type backlight that includes, as light sources, red (R) LEDs, green (G) LEDs, and blue (B) LEDs.

(b) of FIG. 18 is a plan view of a backlight 40 of the present embodiment. The backlight 40 is, as illustrated in (a) of FIG. 18, a direct type backlight including LEDs 42 on a bottom of a housing 41 such that the LEDs 42 emit light through a diffusing plate 43.

The LEDs 42, as illustrated in (b) of FIG. 18, include (i) red LEDs 42r each of which emits red light, (ii) green LEDs 42g each of which emits green light, and (iii) blue LEDs 42b each of which emits blue light. In the backlight 40, three LEDs, namely a red LED 42r, a green LED 42g, and a blue LED 42b, linearly arranged in that order constitute a set, so that the backlight 40 includes a plurality of such sets of LEDs 42 arranged sequentially. This arrangement causes respective light beams from the LEDs 42 to mix with one another, so that white light is emitted from the diffusing plate 43.

The backlight 40 includes LEDs that are evenly spaced from one another. The LEDs may, however, be combined in any manner or arranged in any order other than the above example, provided that the LEDs are arranged so that their respective light beams are mixed with one another to produce white light. For example, to improve luminous efficiency of each LED, the backlight 40 may include green LEDs 42g in a number greater than the number of red LEDs 42r or the number of blue LEDs 42b. Specifically, a set of LEDs 42 may include a single red LED 42r, two green LEDs 42g, and a single blue LED 42b. The backlight 40 may also include a combination of (i) LEDs having the three colors of red, green, and blue and (ii) white LEDs.

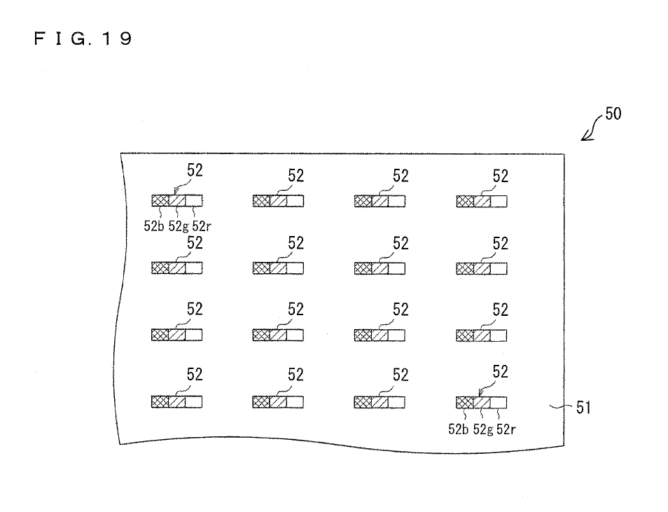

FIG. 19 is a plan view illustrating a backlight 50 of the present embodiment. The backlight 50 includes sixteen LEDs 52 provided on a housing 51 and spaced from one another by a predetermined distance. The LEDs 52 are each a three-in-one (3-in-1) type light-emitting diode integrally including a red LED 52r, a green LED 52g, and a blue LED 52b. Each LED 52, in which the LEDs 52r, 52g, and 52b emit their respective light beams that are mixed with one another, functions as a white-light source.

The following describes an example in which the backlight is an edge-light type backlight.

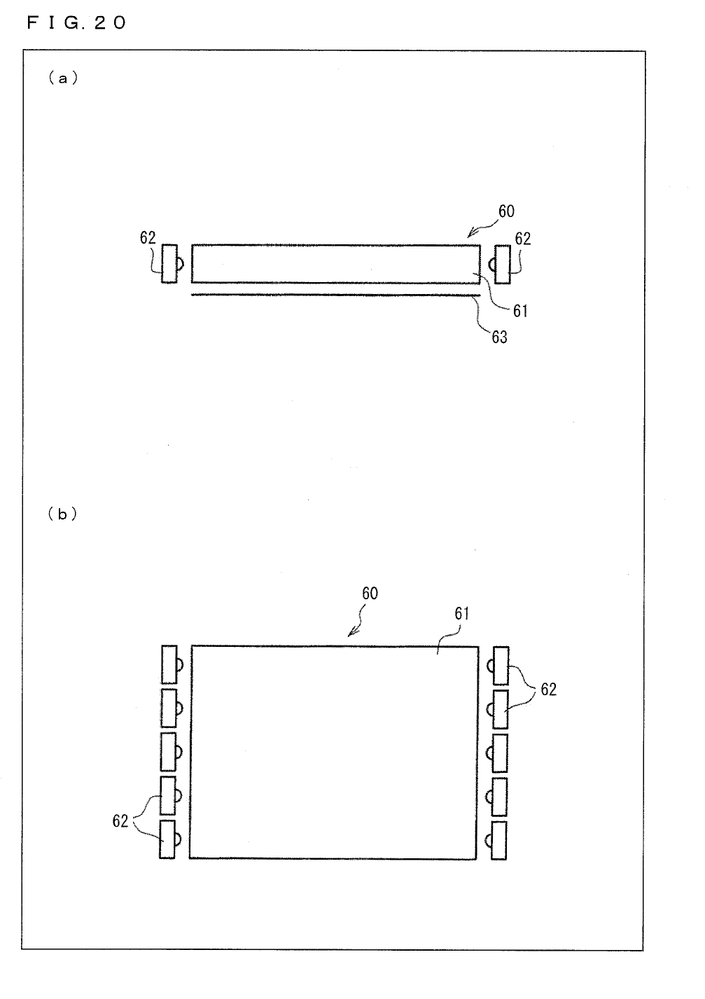

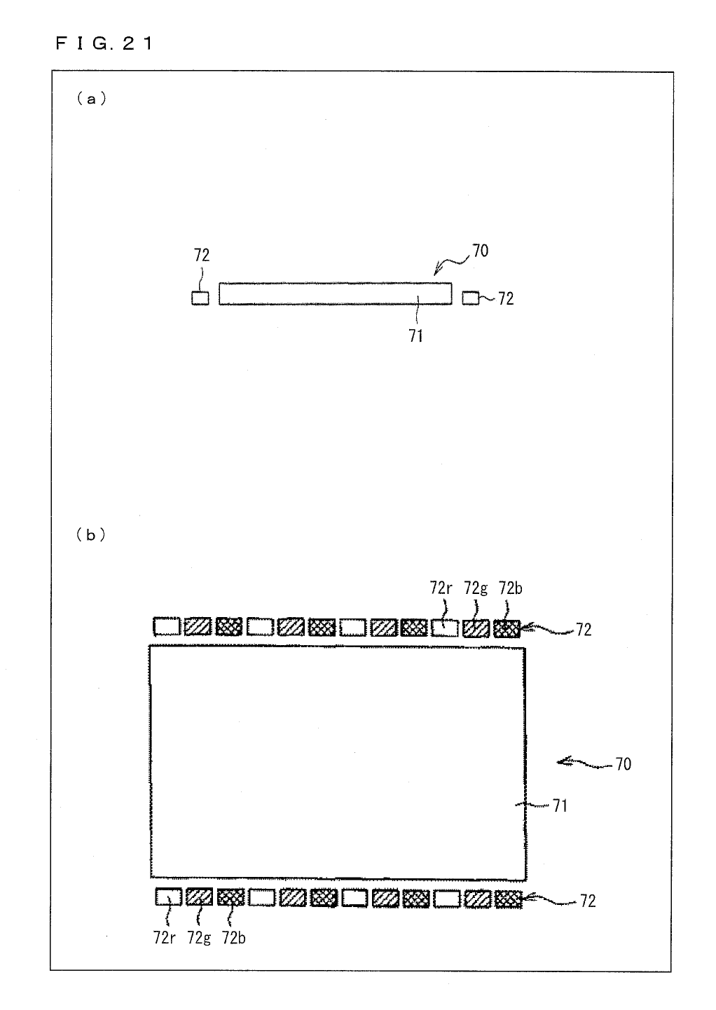

(a) of FIG. 20 is a cross-sectional view schematically illustrating a backlight 60 of the present embodiment. (b) of FIG. 20 is a plan view illustrating the backlight 60. The backlight 60 is, as illustrated in (a) of FIG. 20, an edge-light type backlight including a light guide plate 61, LEDs 62, and a reflecting sheet 63. The LEDs 62 are, as illustrated in (b) of FIG. 20, linearly arranged to the left and to the right of the light guide plate 61 as viewed from a liquid crystal panel.

The light guide plate 61 is arranged such that the LEDs 62 emit light, which is incident on side surfaces of the light guide plate 61 and is then emitted from an upper surface thereof toward the liquid crystal panel. This arrangement causes the light guide plate 61 to emit planar illumination light toward the liquid crystal panel. The backlight 60 includes, as the LEDs 62, white LEDs each of which emits white light.

The LEDs 62 in the backlight 60 are linearly arranged to the left and to the right of the light guide plate 61. The present invention is, however, not limited to such an arrangement. The LEDs 62 may instead be linearly arranged above and below the light guide plate 61 as viewed from the liquid crystal panel. Alternatively, the LEDs 62 may be linearly arranged only (i) either to the left or to the right of the light guide plate 61 or (ii) either above or below the light guide plate 61. Further, the backlight 60 may include, as the light sources, LEDs having the three colors of red, green, and blue.

(a) of FIG. 21 is a cross-sectional view schematically illustrating a backlight 70 of the present embodiment. (b) of FIG. 21 is a plan view illustrating the backlight 70. The backlight 70 is, as illustrated in (a) of FIG. 21, an edge-light type backlight including a light guide plate 71 and LEDs 72. The LEDs 72 are, as illustrated in (b) of FIG. 21, linearly arranged above and below the light guide plate 71 as viewed from a liquid crystal panel.

The LEDs 72 include red LEDs 72r, green LEDs 72g, and blue LEDs 72b. In (b) of FIG. 21, a red LED 72r, a green LED 72g, and a blue LED 72b are linearly arranged in that order from left to right. The LEDs 72 emit their respective light beams, which are mixed with one another inside the light guide plate 71, so that white light is emitted from an upper surface of the light guide plate 71.

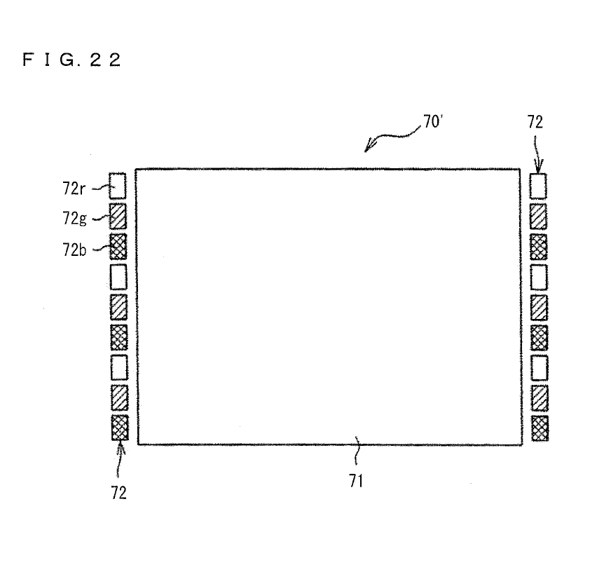

The LEDs 72 in the backlight 70 are linearly arranged above and below the light guide plate 71 as viewed from the liquid crystal panel. The present invention is, however, not limited to such an arrangement. The LEDs 72 may instead be linearly arranged either above or below the light guide plate 71. Alternatively, the LEDs 72 may be linearly arranged to the left and to the right of the light guide plate 71 as in a backlight 70′ illustrated in FIG. 22. The LEDs 72 in the backlight 70′ may instead be linearly arranged either to the left or to the right of the light guide plate 71.

In the case where the backlight 70 includes LEDs having the three colors of red, green, and blue, such LEDs may be spaced from one another by a predetermined distance, or may constitute LED packages each including three LEDs having the respective three colors.

(a) of FIG. 23 is a cross-sectional view schematically illustrating a backlight 80 of the present embodiment. (b) of FIG. 23 is a plan view illustrating the backlight 80. The backlight 80, as illustrated in (a) of FIG. 23, includes: a light guide plate 81; a plurality of LED packages 82; a reflecting sheet 83; a substrate 84; a chassis 85 that contains all of the above components; and optical sheets 86 provided on top of each other to face a front surface of the light guide plate 81. The light guide plate 81 has a left side surface that serves as an entrance surface 81a at which light from the LED packages 82 enters the light guide plate 81. This arrangement causes the light guide plate 81 to (i) diffuse light that has entered the light guide plate 81 through the entrance surface 81a and (ii) guide the light to the right in (a) of FIG. 23.

The LED packages 82 are mounted on a front surface of the substrate 84 contained in the chassis 85, and linearly arranged in a direction along the entrance surface 81a of the light guide plate 81. The LED packages 82 each include a plurality of LEDs that are integrated with one another and that have at least two colors that are different from one another. As illustrated in (b) of FIG. 23, a single LED package 82 in the present embodiment includes a set of three LEDs 82r, 82g, and 82b having the respective colors of red, green, and blue. The LED packages 82 are each, for example, a three-color LED (for example, NSSM038A available from Nichia Corporation) commonly referred to as “multi-chip package”.

The LED packages 82 are each simply required to include a red (R) LED, a green (G) LED, and a blue (B) LED, and may further include an LED of another color.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims.

The display control device of the present invention may preferably be arranged such that the LED luminance control means causes the LED corresponding to the specific region to be off during the period in which the interpolation image is displayed.

The above arrangement causes the LED corresponding to the specific region to be off during the period in which the interpolation image is displayed. This perfectly prevents a broken interpolation image from being visible.

The display control device of the present invention may preferably be arranged such that the LED luminance control means controls the plurality of LEDs so that the LED corresponding to the specific region has a second luminance during a period in which the original image is displayed, the second luminance being higher than the luminance of the LED corresponding to the normal region.

The above arrangement compensates for a decrease in the average luminance of the LED corresponding to the specific region which decrease is caused by lowering the luminance of the LED during the period in which the interpolation image is displayed. This improves uniformity in luminance over the entire liquid crystal panel.

The display control device of the present invention may preferably be arranged such that the LED luminance control means controls the plurality of LEDs so that the LED corresponding to the specific region has an average luminance over a frame period, the average luminance being equal to the luminance of the LED corresponding to the normal region.

The above arrangement allows the luminance over the entire liquid crystal panel to be perfectly uniform.

The display control device of the present invention may preferably further include: image brightness control means for correcting image brightness for the specific region so that for an image displayed by the liquid crystal panel, brightness in the specific region is equal to brightness in the normal region.

With the above arrangement, even if brightness of an image displayed on the liquid crystal panel varies between the specific region and the normal region as a result of LED luminance control by the LED luminance control means, the image brightness control means causes brightness in the specific region to be equal to brightness in the normal region.

The display control device of the present invention may preferably be arranged such that the backlight is a direct type backlight.

The display control device of the present invention may be arranged such that the backlight is an edge-light type backlight that includes a light guide plate such that the plurality of LEDs are provided on at least one side end surface of the light guide plate.

The display control device of the present invention may be arranged such that the plurality of LEDs are provided on at least one of a right side end surface and a left side end surface of the light guide plate as viewed from the liquid crystal panel.

The display control device of the present invention may be arranged such that the plurality of LEDs are provided on at least one of an upper side end surface and a lower side end surface of the light guide plate as viewed from the liquid crystal panel.

The display control device of the present invention may be arranged such that the backlight includes, as the plurality of LEDs, white LEDs each of which emits white light.

The display control device of the present invention may be arranged such that the backlight includes, as the plurality of LEDs, (i) a red LED that emits red light, (ii) a green LED that emits green light, and (iii) a blue LED that emits blue light.

The display control device of the present invention may preferably be arranged such that the green LED is provided in a number greater than a number of the red LED or a number of the blue LED. This improves luminous efficiency.

The display control device of the present invention may be arranged such that a single red LED, a single green LED, and a single blue LED constitute a single LED package.

The display control device of the present invention may preferably be arranged such that a single red LED, two green LEDs, and a single blue LED constitute a single LED package. This improves luminous efficiency.

A liquid crystal display device of the present invention includes the above display control device.

The above arrangement makes it possible to provide a liquid crystal display device which prevents (i) an afterimage from appearing, (ii) an interpolation image broken due to a multiple rate drive from being visible, and (iii) a flicker from being visible due to black image insertion.

A program of the present invention is a program for causing a computer to function as each of the means of the above display control device. A recording medium of the present invention is a recording medium on which the program is recorded.

### INDUSTRIAL APPLICABILITY

The present invention is suitably applicable to a liquid crystal display device that includes, as a light source, a backlight including a plurality of LEDs.

### REFERENCE SIGNS LIST

1 liquid crystal television (liquid crystal display device)

16 display control section (display control device)

19 CPU

21 multiple rate conversion section (multiple rate driving means)

22 motion information detecting section (motion information detecting means)

23 black insertion region determining section (motion information detecting means)

24 LED luminance control section (LED luminance control means)

25 image brightness control section (image brightness control means)

26 liquid crystal panel

27 backlight

28 LED

28a LED

28b LED

40 backlight

42 LED

42r red LED

42g green LED

42b blue LED

43 diffusing plate

50 backlight

52 LED

52r red LED

52g green LED

52b blue LED

60 backlight

61 light guide plate

62 LED

70 backlight

70′ backlight

71 light guide plate

72 LED

72r red LED

72g green LED

72b blue LED

80 backlight

81 light guide plate

82 LED package

82r red LED

82g green LED

82b blue LED

R region

Ra normal region

Rb black insertion region

1-17. (canceled)

18. A display control device for controlling an image display carried out by a liquid crystal panel that uses, as a light source, a backlight including a plurality of LEDs,
the display control device comprising:
multiple rate driving means for driving the liquid crystal panel at an n-fold rate by (i) dividing a frame period into n subframes (where n is an integer of 2 or greater) and (ii) inserting between frames an interpolation image created on a basis of a change in an original image;
motion information detecting means for determining complexity of a motion of the original image for each of a plurality of regions of the liquid crystal panel; and
LED luminance control means for controlling the plurality of LEDs so that an LED corresponding to a specific region, for which the motion of the original image has been determined by the motion information detecting means to be complex, has a first luminance during a period in which the interpolation image is displayed, the first luminance being lower than a luminance of an LED corresponding to a normal region, which is a region other than the specific region,
the motion information detecting means, with reference to a circular classification table (i) in which points indicative of respective motions for each of the plurality of regions are plotted on a basis of a direction and a magnitude of each of said respective motions and (ii) which is divided into a plurality of sections positioned in point symmetry with respect to a central portion of the classification table, (A) calculating, for each combination of said respective motions for each of the plurality of regions, a minimum number of a boundary line between points which boundary line is other than an intersection of a side of a section with a side of another section, and (B) determining the complexity for each of the plurality of regions on a basis of a greatest number among the minimum numbers.

19. The display control device according to claim 18,
wherein:
the LED luminance control means causes the LED corresponding to the specific region to be off during the period in which the interpolation image is displayed.

20. The display control device according to claim 18,
wherein:
the LED luminance control means controls the plurality of LEDs so that the LED corresponding to the specific region has a second luminance during a period in which the original image is displayed, the second luminance being higher than the luminance of the LED corresponding to the normal region.

21. The display control device according to claim 20,
wherein:
the LED luminance control means controls the plurality of LEDs so that the LED corresponding to the specific region has an average luminance over a frame period, the average luminance being equal to the luminance of the LED corresponding to the normal region.

22. The display control device according to claim 18, further comprising:
image brightness control means for correcting image brightness for the specific region so that for an image displayed by the liquid crystal panel, brightness in the specific region is equal to brightness in the normal region.

23. The display control device according to claim 18,
wherein:
the backlight is a direct type backlight.

24. The display control device according to claim 18,
wherein:
the backlight is an edge-light type backlight that includes a light guide plate such that the plurality of LEDs are provided on at least one side end surface of the light guide plate.

25. The display control device according to claim 24,
wherein:
the plurality of LEDs are provided on at least one of a right side end surface and a left side end surface of the light guide plate as viewed from the liquid crystal panel.

26. The display control device according to claim 24,
wherein:
the plurality of LEDs are provided on at least one of an upper side end surface and a lower side end surface of the light guide plate as viewed from the liquid crystal panel.

27. The display control device according to claim 18,
wherein:
the backlight includes, as the plurality of LEDs, white LEDs each of which emits white light.

28. The display control device according to claim 18,
wherein:
the backlight includes, as the plurality of LEDs, (i) a red LED that emits red light, (ii) a green LED that emits green light, and (iii) a blue LED that emits blue light.

29. The display control device according to claim 28,
wherein:
the green LED is provided in a number greater than a number of the red LED or a number of the blue LED.

30. The display control device according to claim 28,
wherein:
a single red LED, a single green LED, and a single blue LED constitute a single LED package.

31. The display control device according to claim 28,
wherein:
a single red LED, two green LEDs, and a single blue LED constitute a single LED package.

32. A liquid crystal display device, comprising:
the display control device according to claim 18.

33. A computer-readable recording medium on which a program for causing a computer to function as each of the means of the display control device of claim 18 is recorded.
